(19) United States
(12) Patent Application Publication
(10) Pub. No.: US 2013/0220935 A1
(43) Pub. Date: Aug. 29, 2013

(54) REMOVAL OF 1,4-DIOXANE FROM WATER USING CARBONACEOUS ADSORBENTS

(71) Applicants: Eric G. Isacoff, Lake Worth, FL (US); Michael Gary Nickelsen, Bloomfield, NY (US)

(72) Inventors: Eric G. Isacoff, Lake Worth, FL (US); Michael Gary Nickelsen, Bloomfield, NY (US)

(21) Appl. No.: 13/408,085

(22) Filed: Feb. 29, 2012

(51) Int. Cl. C02F 1/58; B01J 20/34; C02F 1/28

(52) U.S. Cl. 210/673; 210/694; 210/674; 210/670

(57) ABSTRACT

The present invention relates to the use of a carbonaceous adsorbent for the removal of a recalcitrant compound (1,4-dioxane) from contaminated water. The adsorbent is able to reduce the concentration of 1,4-dioxane from thousands of μg/L to <3 μg/L (the current EPA guideline). In addition, the adsorbent is regenerable in place with low pressure steam.

The present invention relates to the use of a carbonaceous adsorbent for the removal of a recalcitrant compound (1,4-dioxane) from contaminated water. The adsorbent is able to reduce the concentration of 1,4-dioxane from thousands of μg/L to <3 μg /L (the current EPA guideline). In addition, the adsorbent is regenerable in place with low pressure steam.

1,4-dioxane has been used as a stabilizer in 1,1,1-trichlororoethane and other chemicals. This recalcitrant compound has been found in many groundwater sites especially those areas associated with the aerospace industry. There are close to 100 sites that the United Sates EPA has identified that contain levels of 1,4-dioxane above the targeted level of 3 μg/L.

1,4-Dioxane (C₄H₈O₂) is flammable, toxic, and potentially explosive; thus 1,4-dioxane in byproduct streams must be destroyed or removed and disposed of safely. However, removal and disposal of 1,4-dioxane can be difficult. 1,4-Dioxane is very resistant to existing removal techniques. Furthermore, 1,4-dioxane and water have very similar boiling points, so that conventional distillation techniques based on differences in boiling point can be difficult.

1,4-Dioxane removal and disposal is further complicated if the compound condenses, because of additional safety hazards that arise. Further, 1,4-dioxane condensation triggers additional federal regulations which must be met to satisfy regulatory standards for the safe disposal of the liquid form. This increases the cost and difficulty of 1,4-dioxane removal and disposal.

Currently, the primary treatment technique for remediation of streams containing 1,4-dioxane has been advanced oxidation processes (AOP). Although this technology has proven to be effective, there are issues that make it a less desirable option, such issues include but are not limited to: high capital costs; high chemical usage; safety; excessive operator involvement; and potential formation of undesirable byproducts especially when bromide ion is present.

One technique suggested for separating water and 1,4-dioxane is set forth in Japanese Application 55164679. The application discloses drying cyclic ethers, including 1,4-dioxane, by contacting the wet cyclic ether with an aqueous solution of an alkali metal hydroxide and an alkali metal halide.

Other techniques separate water from 1,4-dioxane by distillation. For example, Japanese Application 74027587 teaches distilling an 80% 1,4-dioxane and 20% water mixture. Japanese Application 73043510 teaches distilling water-containing 1,4-dioxane at ambient temperatures to recover condensed 1,4-dioxane. Russian Application 256780 teaches azeotropic removal of water from 1,4-dioxane.

It is an object of the present invention to provide a process for the removal of 1,4-dioxane from water comprising:
a. providing water comprising 1,4-dioxane and
b. contacting the water with a carbonaceous adsorbent particle
wherein the 1,4-dioxane adsorbs onto the carbonaceous adsorbent particle and is removed from the water.

The present invention meets this and other objects by removing 1,4-dioxane from water byproduct streams resulting from chemical processes.

### BRIEF DESCRIPTION OF THE DRAWINGS

FIG. 1 is an equilibrium adsorption isotherm plot of the residual concentration of 1,4-dioxane expressed in mg/L versus the capacity of sample test resins, adsorbents and other organic media expressed in mg/g.

FIG. 2 is a column multicycling study plot of bed volumes of water comprising 1,4-dioxane that were processed versus the column effluent 1,4-dioxane concentration expressed in ug/L.

As used herein by “water” may be in liquid, or gaseous/vaporous state (water vapor or steam), or mixtures thereof. The water may comprise 1,4-dioxane either alone or in combination with chlorinated volatile organic compounds, volatile organic compounds, and/or hydrocarbons. Preferably, according to the present invention, the chlorinated volatile organic compounds, volatile organic compounds and/or hydrocarbons are present at levels at or below 5 mg/L.

As used herein by “1,4-dioxane” is meant the product produced by the acid-catalysed dehydration of diethylene glycol, which in turn arises from the hydrolysis of ethylene oxide. The teen 1,4-dioxane, as used in the present invention, includes all isomers of dioxane either alone or in combination with one or more isomers. 1,4-dioxane is preferred in the present invention

As used herein, the term “micropore” is used to mean pores of average diameter from greater than 500 Å. “Micropore” refers to pore values of average diameter less than 20 Å. An additional designation are “mesopores”, which term is used herein to mean pores having an average diameter from 20-500 Å.

All percentages are weight percents unless otherwise noted.

According to the present invention, water containing 1,4-dioxane is contacted with a carbonaceous adsorbent particle. Following contact with the carbonaceous adsorbent particle, the 1,4-dioxane is adsorbed onto the carbonaceous adsorbent particle and the 1,4-dioxane is removed from the water. Typically the contact between the carbonaceous adsorbent particle and the water containing 1,4-dioxane occurs in an adsorption column. The adsorption column can be any column known to those of ordinary skill in the art. Suitable adsorption columns may be manufactured with glass, stainless steel or other such non-corrosive metal alloys. The adsorption process typically occurs under ambient temperature ranging from 10 to 50° C., preferably 10 to 38° C. and more preferably 15 to 25° C. and operates at pressures of less than 334.7 kPa, preferably less than 202.7 kPa. Preferably the pressure is not less than 34.47 kPa.

In the present invention when chlorinated volatile organic compounds, volatile organic compounds, and/or hydrocarbons exist in water at levels equal to or above 5 mg/L an alternative adsorbent is preferably contacted with the water sample prior to contacting the water with the carbonaceous adsorbent particle. A suitable alternative adsorbent includes but is not limited to polymeric adsorbents, activated carbon, or mixtures thereof.

The adsorbed 1,4-dioxane may be eluted from the carbonaceous adsorbent particle and the carbonaceous adsorbent particle may be regenerated by rinsing the carbonaceous adsorbent particle with at least one solvent. Suitable solvents include solvents known to those of ordinary skill in the art and include but are not limited to alcohols or ketones. Preferably, the 1,4-dioxane is eluted from the carbonaceous adsorbent particle and the carbonaceous adsorbent is regenerated with low pressure steam. As used herein by “low pressure” is defined as pressure ranging from 103.4 to 344.7 kPa, and in the present invention is preferably saturated or superheated steam. The 1,4-dioxane may be eluted from the carbonaceous adsorbent particle and the carbonaceous adsorbent may also be regenerated with a combination of application of low pressure steam and treatment with a solvent either simultaneously or sequentially.

The carbonaceous adsorbent particles of the present invention have high surface area and a minimum volume contributed by micropores of 0.02 cm³/g, preferably 0.05 cm³/g, and more preferably 0.1 cm³/g, which particles are made by the partial pyrolysis of macroporous, polysulfonated resins. The adsorbent particles of the present invention are made by partially pyrolyzing, in an inert atmosphere, at temperatures from 300° to 1200° C., polysulfonated, macroporous, vinylaromatic copolymers. The adsorbent particles may then be activated by heating in an activating atmosphere.

The carbonaceous adsorbent particles of the present invention are vinyl aromatic polymers in which at least 50% of the units contain a vinylaromatic group. Preferred are vinylaromatic polymers in which at least 90% of the units contain a vinylaromatic group. Especially preferred are vinylaromatic polymers where at least 98% of the units contain a vinylaromatic group. Vinylaromatic monomers include, among others, styrene, alpha-methylstyrene, vinyltoluene, p-methylstyrene, ethyl-vinylbenzene, vinylnaphthalene, divinylbenzene, trivinylbenzene, vinylisopropenylbenzene, diisopropenylbenzene, and the like. Especially preferred are styrene and divinylbenzene (which will normally contain some ethylvinylbenzene).

The carbonaceous adsorbent particles of the present invention comprise polyvinyl crosslinker level in an amount from 2% to 98% by weight of the copolymer, with the preferred range being from 3% to 80% by weight of the carbonaceous adsorbent particle copolymer. Suitable crosslinkers include those taught in U.S. Pat. No. 4,040,990. Combinations of crosslinkers may also be used.

Suitable carbonaceous adsorbents of the present invention include those made by the process disclosed in Maroldo et al., U.S. Pat. No. 4,839,331. Additionally, the carbonaceous adsorbent particles of the present invention may be functionalized by methods such as taught in Beasley et al., U.S. Pat. No. 4,265,768 to incorporate ion exchange functional groups or precursors thereof; the resulting functionalized particles are useful as ion exchange resins.

The carbonaceous adsorbent particles of the present invention produce a surprising result in comparison to other hydrophobic synthetic adsorbents. Isotherm studies demonstrate an extremely high affinity of carbonaceous adsorbent particle for 1,4-dioxane even at low concentrations. The capacity observed was significantly higher than for polymeric adsorbents and GAC. This can be seen in the equilibrium isotherm figures of the present invention. This is especially important since most of the contaminated streams contain 1,4-dioxane at concentrations less than 5 mg/L.

### Test Methods

Equilibrium isotherm studies were performed following the procedure listed below comparing two polymeric adsorbents, one carbonaceous adsorbent and liquid phase granular activated carbon (“GAC”). The polymeric adsorbents evaluated were DOWEX™ OPTIPORE™ L493 adsorbent which is a methylene bridged polymer of styrene and divinylbenzene, available from The Dow Chemical Company and AMBERLITE™ XAD4 adsorbent which is a non-ionic, macroreticular crosslinked aromatic styrene/divinylbenzene copolymer, available from The Dow Chemical Company.

The carbonaceous adsorbent evaluated was AMBERSORB™ 563 a carbonaceous adsorbent having the following properties:

| | |
|---|---|
| Physical Form Black, spherical beads; | |
| Particle Size Distribution | 20 to 50 mesh |
| | (U.S. Sieve Series); |
| Mean Particle Diameter (mm) | 0.45; |
| BET Surface Area (m²/g) | 550; |
| Bulk Density (g/cc) | 0.53; |
| Crush Strength (g/bead) | >1000; |
| Pore Size Distribution; | |
| Micropore Volume (cc/g) | 0.23 |
| Mesopore Volume (cc/g) | 0.14 |
| Macropore Volume (cc/g) | 0.23 |
| Total Pore Volume (cc/g) | 0.60; and |
| Water Adsorption (at 80% Relative | 10%; |
| Humidity) | |

available from The Dow Chemical Company.

The GAC evaluated was Filtrasorb 400 liquid phase granular activated carbon, available from Calgon Carbon Corporation.

### EXAMPLE 1

### Equilibrium Isotherm

### Test Method

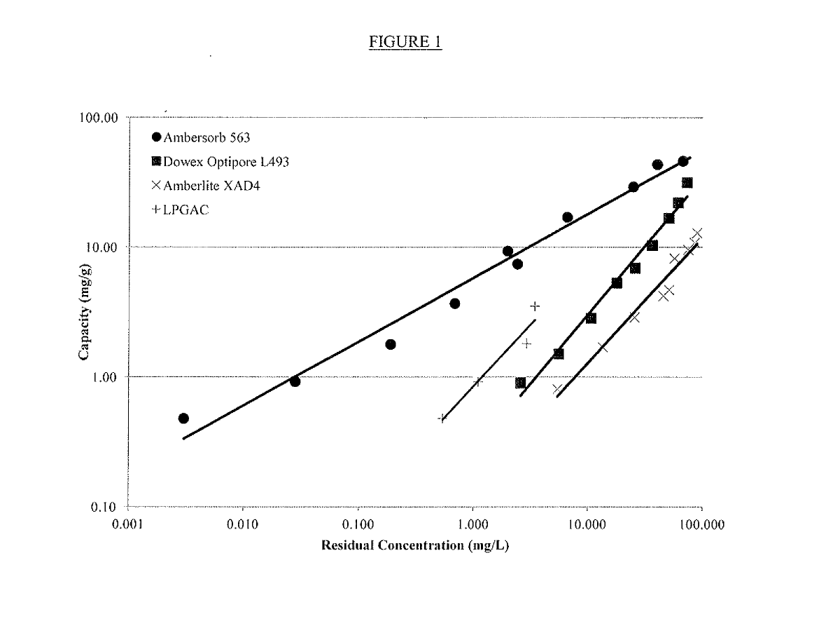

1) Determined the percent solids of the polymeric or carbonaceous adsorbent by placing a small fraction (4-5 g) in a 105° C. oven overnight.
2) Added a minimum of four separate weights of the adsorbents which were placed in separate 60 mL serum vials.
   a) AMBERSORB™ 563 adsorbent—10 separate weights of adsorbent were used ranging from 0.033 to 10.21 g.
   b) OPTIPORE™ L493 adsorbent—9 separate weights of adsorbent were used ranging from 0.103 to 13.85 g.
   c) Amberlite XAD4 Optipore L493—9 separate weights of adsorbent were used ranging from 0.082 to 13.96 g.
   d) GAC—4 separate weights of adsorbent were used ranging from 2.13 to 16.04 g.
3) Carefully pipetted 50 mL of a 98.14 mg/L 1,4-dioxane aqueous solution into each vial.
4) Agitated the sealed vials on a rotary mixer for 24 hours, while maintaining the temperature at 20±2° C.
5) Allowed the resin to settle and measured the residual concentration of 1,4-dioxane in the supernatant by gas chromatography.
6) Prepared a 1,4-dioxane calibration curve by means of serial dilutions to measure the concentration throughout the range. The calibration curve ranged from 10 to 2000 ug/L.
7) Tabulated the data as shown in the Table 1 below, and plot as shown in the FIG. 1 below.
8) Plotted the log of the adsorption capacity versus the log of the residual concentration as shown in the figure below. Typically a Freundlich analysis is utilized.

TABLE 1
Tabulation of Capacity as a Function of Concentration
(Assume 200 ml of 50 mg/L (C_{I}) Analyte)

| Adsorbent Weight | Residual | Weight | |
|---|---|---|---|
| Dry (A_{W}) | Concentration (C_{R}) | Adsorbed (W_{A}) | Capacity |
| (g) | (mg/L) | (mg) | (mg/g) |
| 0 | 50 | 0 | 0 |
| 0.1005 | 3.55 | 9.29 | 92.44 |
| 0.1998 | 0.53 | 9.89 | 49.52 |
| 0.4000 | 0.10 | 9.98 | 24.95 |

C_{I} = Initial Concentration
C_{R} = Residual Concentration
W_{A} = Weight Adsorbed
A_{W} = Adsorbent Weight
V_{R} = Volume Ratio (1000 ml/200 ml = 5)
W_{A} = C_{I} − C_{R}/V_{R}
Capacity = W_{A}/A_{W}

The results of this study as shown in FIG. 1, demonstrate that the carbonaceous adsorbent had at least 10× the capacity of any other sample tested at the concentration(s) of interest (˜1 mg/L) of 1,4-dioxane. As the equilibrium concentration approaches 0.1 mg/L, the capacity advantage increases. Most affected water supplies contain less than 1 mg/L of 1,4-dioxane making the carbonaceous adsorbent the preferred treatment technology over the other adsorbents tested.

### EXAMPLE 2

### Columnar Loading Study of Carbonaceous Adsorbent and

### Columnar Loading Test Method

Based on the results obtained in the equilibrium isotherm, the carbonaceous adsorbent AMBERSORB™ 563 adsorbent was selected for further study with a kinetic columnar loading study to determine both working capacity and low level leakage characteristics.

Approximately 1 liter of carbonaceous adsorbent was charged to the glass chromatography column (Ace Glass 5820-55) with the dimensions of 5.08 cm in diameter and 60.98 cm high. After rinsing the adsorbent with deionized water, it was challenged in the upflow fixed bed mode at an empty bed contact time (EBCT) of 6 minutes (10 BV/Hr) with a stream containing 1100-1300 μg/L of 1,4-dioxane in tap water. After the column effluent surpassed the targeted concentration of 3 μg/l, it was stopped.

As the data show, the adsorbent was able to treat approximately 600 BV to the targeted (3μg/L) 1,4-dioxane leakage level.

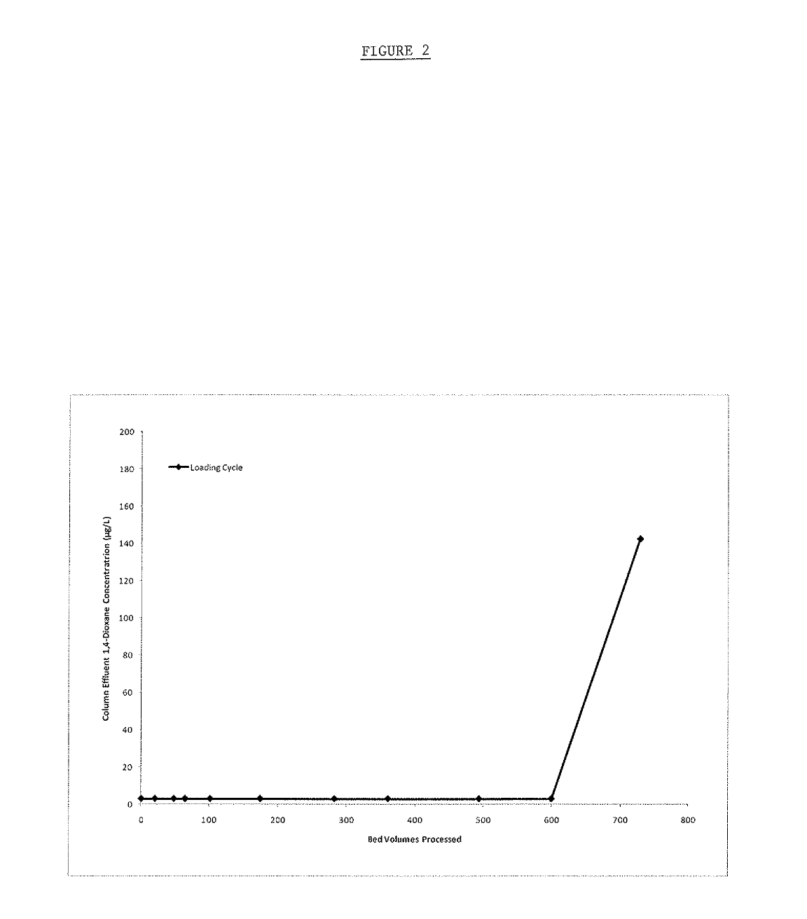

The analytical procedure utilized for both the isotherm and columnar studies is presented in Table 2. The results of the column study are presented in Table 3 and FIG. 2.

TABLE 2
1,4-Dioxane Analytical Procedure

Column Dimensions: 5.08 cm × 60.98 cm (2″ × 24″) Glass
Bed Volume = 1 L
EBCT = 6 minutes
Sample analysis via purge & trap sample
preparation followed by gas chromatography
Analytical:
Tekmar ALS 2010
Tekmar LSC 2000
Hewlett Packard 5890 Series II - Gas Chromatograph
Detector Flame Ionization Detector (FID)
Chromatography Column: Supelco SPB-1, 60 m × 0.53 mm × 5 um film
Oven program: 30° C. (10 min hold) - 6° C./min ramp - 200° C.
(11.67 min hold)
Purge gas: Helium @ 30 mL/min
Carrier gas - Helium @ 3 mL/min
Detector gases:
Air @300 mL/min
Hydrogen @30 mL/min
Helium @ 24 mL/min (make-up gas)

TABLE 3
Column Loading Study
Loading Cycle

| | 1,4-Dioxane |
|---|---|
| BV | (ug/L) |
| Influent | 1110.1 |
| 0 | ND < 2.9 |
| 20.4 | ND < 2.9 |
| 48.4 | ND < 2.9 |
| 65.1 | ND < 2.9 |
| 101.8 | ND < 2.9 |
| 174.1 | ND < 2,9 |
| 282.7 | ND < 2.9 |
| 361.1 | ND < 2.9 |
| 493.9 | ND < 2.9 |
| 599.5 | ND < 2.9 |
| 729.3 | 142.3 |

We claim:

1. A process for the removal of 1,4-dioxane from water comprising:
a. providing water comprising 1,4-dioxane and
c. contacting the water with a carbonaceous adsorbent particle
wherein the 1,4-dioxane adsorbs onto the carbonaceous adsorbent particle and is removed from the water.

2. The process of claim 1 further wherein the adsorbed 1,4-dioxane is eluted from the carbonaceous adsorbent particle and the carbonaceous adsorbent particle is regenerated by treating with low pressure steam.

3. The process of claim 1 further wherein the adsorbed 1,4-dioxane is eluted from the carbonaceous adsorbent particle and the carbonaceous adsorbent particle is regenerated by rinsing the carbonaceous adsorbent particle with at least one solvent.

4. The process of claim 3 wherein the solvent is a ketone.

5. The process of claim 3 wherein the solvent is an alcohol.

6. The process of claim 2 wherein the low pressure steam is saturated steam.

7. The process of claim 2 wherein the low pressure steam is superheated steam.
